(19) United States
(12) Patent Application Publication
(10) Pub. No.: US 2018/0065145 A1
(43) Pub. Date: Mar. 8, 2018

(54) STEEL WIRE SURFACE TREATMENT METHOD AND SURFACE TREATMENT LINE

(71) Applicant: Kabushiki Kaisha Kobe Seiko Sho (Kobe Steel, Ltd.), Kobe-shi (JP)

(72) Inventor: Satoshi NAKANO, Kobe-shi (JP)

(73) Assignee: Kabushiki Kaisha Kobe Seiko Sho (Kobe Steel, Ltd.), Kobe-shi (JP)

(21) Appl. No.: 15/554,519

(22) PCT Filed: Mar. 23, 2016
(86) PCT No.: PCT/JP2016/059184

§ 371 Date: Aug. 30, 2017

(30) Foreign Application Priority Data
Mar. 26, 2015 (JP) 2015-064526

(51) Int. Cl. B05D 3/00; B21C 43/04; B05D 7/20; B05D 7/14

(52) U.S. Cl. CPC B05D 3/002; B05D 7/14; B05D 7/20; B21C 43/04

(57) ABSTRACT

The steel wire surface treatment method of the present invention is a method for continuously treating the surface of a steel wire and includes: a descaling step P2 in which scale adhering to the surface of a steel wire is removed by subjecting the surface of the steel wire to wet blasting; a coating film treatment step P5 in which a coating film is formed on the surface of the steel wire after completion of the descaling step P2; and a water amount controlling step P3 in which the water amount on the surface of the steel wire immediately before performing the coating film treatment step P5 is adjusted to a prescribed water amount.

### TECHNICAL FIELD

The present invention relates to a steel wire surface treatment method, and more specifically to a method of continuously forming a coating film on the surface of a steel wire upon adjustment of the water amount on the surface of the steel wire after descaling the surface of the steel wire.

### BACKGROUND ART

From the past, drawing using a wire-drawing die is performed on a steel wire for the purpose of improving dimension accuracy and mechanical properties of the steel wire. In order to smoothly perform this drawing, a step of removing oxide scale adhering onto the surface of the steel wire (descaling step) and a step of forming a coating film having lubricity on the surface of the steel wire (coating film treatment step) are carried out before drawing. By performing these steps, lubricity is imparted to the surface of the steel wire, so that the drawing can be carried out smoothly.

One example of surface treatments of the steel wire is given, for example, in Patent Literature 1 (Japanese Unexamined Patent Publication No. 07-80772). In Patent Literature 1, first the surface of a steel wire is descaled with use of an ultrahigh pressure water jet. Subsequently, a phosphate chemical conversion treatment and a sodium stearate treatment are carried out in this order to form a lubricating coating film on the surface of the steel wire.

The oxide scale adhering onto the surface of the steel wire can be removed at a high rate, and fine undulations can be formed on the surface of the steel wire by using an ultrahigh pressure water jet as disclosed in Patent Literature 1. Owing to these fine undulations, a phosphate coating film can be efficiently formed in a subsequent coating film treatment step.

### CITATION LIST

### Patent Literature

Patent Literature 1: Japanese Unexamined Patent Publication No. H07-80772

### SUMMARY OF INVENTION

In the steel wire surface treatment method disclosed in Patent Literature 1, there have been cases in which a part of water given by the ultrahigh pressure water jet remains on the surface of the steel wire to cause atmospheric corrosion in the steel wire during the period of time from several seconds to ten and several seconds from the completion of descaling the steel wire to the coating film treatment step. This atmospheric corrosion, even if slight, generates color unevenness (yellowing) on the steel wire surface after processing or lets the corrosion proceed in the processes of subsequent steps to generate a red rust. Moreover, when this atmospheric corrosion proceeds seriously to generate a red rust, rusts themselves or pitting corrosion caused by the rusts remain even in subsequent steps, thereby possibly causing poorness such as mold burning or material cracking during the processing steps.

The present invention has been made in view of the aforementioned circumstances, and an object thereof is to provide a steel wire surface treatment method and a steel wire surface treatment line that form a coating film having a good quality on the steel wire by suppressing the atmospheric corrosion that is liable to occur during the surface treatment processes of the steel wire.

In order to achieve the aforementioned object, the present inventor has made a study on use of the water adhering onto the surface of the steel wire to ensure a water film on the surface of the steel wire during the period until the steel wire reaches the coating film treatment step. As a result thereof, it has been made clear that contact of atmospheric air with the surface of the steel wire can be blocked by the water film on the steel wire surface, and this prevents atmospheric corrosion of the steel wire. However, when the water amount on the surface of the steel wire is excessively large, there is a fear that it may be difficult to form a coating film in the coating film treatment step.

By paying attention to water on the surface of the steel wire after the steel wire is descaled, the present inventor has obtained a knowledge that the water given by the ultrahigh pressure water jet falls off from the steel wire or is naturally evaporated to make the water film on the steel wire surface be too thin, and oxygen is diffused in the water film to let the atmospheric corrosion liable to occur. The present inventor has made further studies based on such a knowledge and has found out that a coating film having a good quality can be formed on the surface while preventing atmospheric corrosion of the steel wire by adjustment of the water amount so that a water film can be formed on the steel wire surface between the descaling step and the coating film treatment step. Here, the following term “wet blasting” means a surface treatment including water jetting and wet blasting.

In other words, a steel wire surface treatment method according to one aspect of the present invention includes: a descaling step of removing scale adhering to the surface of the steel wire by subjecting the surface of the steel wire to wet blasting; a coating film treatment step of forming a coating film on the surface of the steel wire after the descaling step; and a water amount controlling step of adjusting a water amount on the surface of the steel wire immediately before performing the coating film treatment step, to be within a prescribed water amount range.

The present invention is also directed to a steel wire surface treatment line for continuously treating a surface of a steel wire, including: a blasting treatment device for performing wet blasting on the surface of the steel wire; a coating film forming device for forming a coating film on the steel wire after the wet blasting treatment; and a water amount controlling device for adjusting a water amount on the surface of the steel wire immediately before introducing the steel wire into the coating film forming device, to be within a prescribed water amount range.

### BRIEF DESCRIPTION OF DRAWINGS

FIG. 1 is a view showing steps of a continuous surface treatment method according to Embodiment 1.

FIG. 2 is a view schematically showing a surface treatment line for treatments performed by the continuous surface treatment method according to Embodiment 1.

FIG. 3 is a block diagram showing a construction of a water amount controlling device.

FIG. 4 is a flowchart for describing a method of adjusting the water amount on the surface of a steel wire by a water amount controlling unit.

FIG. 5 is a view showing steps of a continuous surface treatment method according to Embodiment 2.

FIG. 6 is a view showing steps of a continuous surface treatment method according to Embodiment 3.

FIG. 7 is a view showing steps of a continuous surface treatment method according to Embodiment 4.

### DESCRIPTION OF EMBODIMENTS

Hereafter, an embodiment of a continuous surface treatment method of the present invention will be described in detail with reference to the drawings.

### Embodiment 1

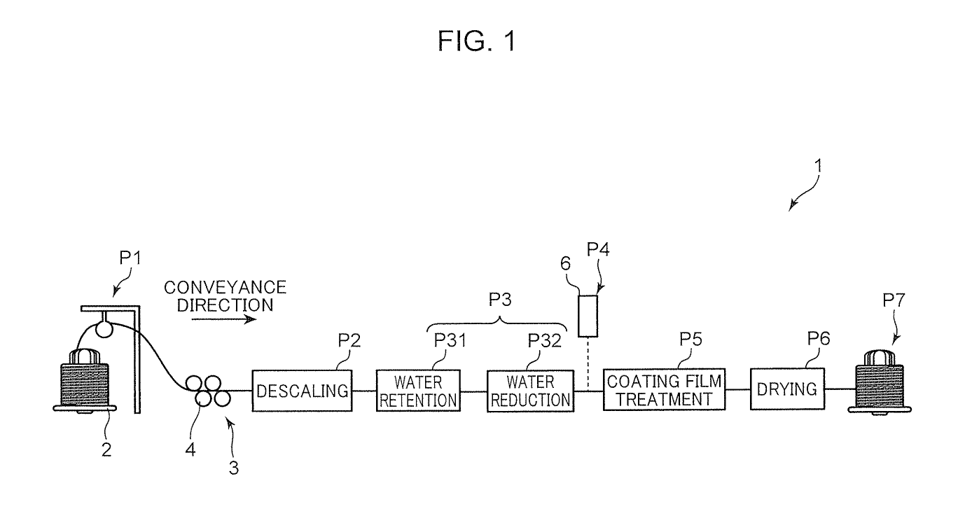

Referring to FIG. 1, a continuous steel wire surface treatment method according to the present embodiment is carried out on a surface treatment line 1 that forms a coating film having lubricity on a steel wire (bar steel wire). The surface treatment line 1 includes a step of paying out a steel wire from a coil of a supply stand 2 (paying-out step P1), a step of removing scale adhering to a surface of the paid-out steel wire (descaling step P2), a step of adjusting a water amount on the surface of the steel wire after descaling (water amount controlling step P3), a step of measuring the water amount on the surface of the steel wire immediately before performing the coating film treatment step, with use of an aquameter 6 (water amount measuring step P4), a step of forming a coating film having lubricity on the surface of the steel wire having a prescribed water amount (coating film treatment step P5), and a step of coiling the steel wire on which the coating film has been formed, with use of a coiling machine (coiling step P7), in this order.

The water amount controlling step P3 includes a water retention step P31 of increasing the water amount on the surface of the steel wire and a water reduction step P32 of decreasing the water amount on the surface of the steel wire. Further, when a lubricant used for forming the coating film in the coating film treatment step P5 is a liquid, the surface treatment line 1 may include a step of drying the lubricant before the coiling step P7 (drying step P6), as illustrated in FIG. 1.

Hereafter, the steel wire subjected to the surface treatment in the continuous surface treatment method, each step constituting the steel wire surface treatment method, and the steel wire surface treatment line will be described.

<Steel Wire>

The steel wire treated in the continuous surface treatment method of the present embodiment is one obtained by rolling a steel or stainless steel to have a long linear shape with use of a hot roller, and has a diameter of 5.0 mm to 55 mm. This steel wire is coiled as a coil after the rolling. After the rolling, a thermal treatment such as annealing may be performed on the steel wire in a batch furnace or a continuous furnace for adjustment of the structure or mechanical properties of the steel wire. Here, the material of the steel wire is not limited to the above-described ones, so that a general wire can be used.

<Steel Wire Surface Treatment Method>

The above steel wire surface treatment method is carried out through the following steps.

(Paying-Out Step P1)

In the paying-out step P1, the steel wire is paid out in a line form from the coil of the steel wire disposed in the supply stand 2. The supply stand 2 is an equipment that supports the coil of the steel wire after hot rolling so that an axial center of the coil is directed in an up-and-down direction or in a horizontal direction. The paying-out of the steel wire is carried out by winding off the steel wire so as to pull out the steel wire in an upward direction from the coil or towards the downstream side of a production line, or by paying out the steel wire while rotating the coil itself in a horizontal plane. Here, referring to FIG. 1, a curl of the paid-out steel wire may be corrected with use of a correction machine 3 so that the steel wire is corrected to have a linear shape. Correction of the curl can be carried out by passing the steel wire through a plurality of correction rolls 4.

(Descaling Step P2)

In the descaling step P2, wet blasting (JIS Z0310:2004) is performed on a surface of the steel wire so as to remove the scale adhering onto the surface. The term “wet blasting” means a surface treatment including water jetting and wet blasting. The wet blasting is an operation of spraying water alone or a slurry obtained by mixing water with hard particles towards an object with use of high-pressure air from a plurality of nozzles so as to let the water or slurry collide against the surface of the steel wire to cut and hit the surface of the steel wire. This can cut out the oxide scale adhering onto the surface of the steel wire and can roughen the surface. The oxide scale can be efficiently removed by appropriately setting the size of the hard particles and the like. Further, this provides an advantage in that powder dusts are less likely to be generated, because scattering of the hard particles can be suppressed with water.

The wet blasting conditions can be appropriately selected, and it is preferable to adjust the air pressure of wet blasting, the distance between the nozzles and the steel wire, the shape and material of abrasive grains, the abrasive grain concentration, and the like. The air pressure of wet blasting is preferably 0.2 MPa or more and 0.6 MPa or less. The distance between the nozzles and the steel wire in wet blasting is preferably 20 mm or more and 200 mm or less. The abrasive grain concentration of wet blasting is preferably 5% by mass or more and 25% by mass or less.

When abrasive grains are used for the wet blasting, it is preferable to use grit-shaped polishing particles. The grit-shaped polishing particles mean grits that are defined as a metal-based polishing material for blasting treatments in JIS Z 0311. The shape of a grit-shaped polishing particle is a cornered shape having dihedral angles in a state before use, in which the occupying ratio of the round parts among the parts of the surface of the particle relative to the total surface of the particle is less than ½. Therefore, this grit-shaped polishing particle has a shape that is largely different from that of a metal-based polishing material for shot treatments defined in JIS Z 0311. The metal-based polishing material for shot treatments is defined in JIS Z 0311 as “spherical particles in which there are no dihedral angles, crushed surfaces, or other sharp surface flaws in a state before use and in which the major diameter is within a double of the minor diameter”. By using such a grit-shaped polishing particle, a work-affected layer is formed on the surface of the steel wire through fine surface cutting caused by the corners of the grit-shaped polishing particle. By this work-affected layer, coating film formation can be prompted, and a coating film having lubricity can be formed in a short period of time in the subsequent coating film treatment step P5.

The type of the metal used in the grit-shaped polishing particle is not particularly limited; however, from the viewpoint of forming efficiency of the descaling step P2, it is preferable to use a particle having a higher hardness than the hardness of the steel wire that is to be treated. Specifically, steel or stainless steel having an excellent toughness is used as the grit-shaped polishing particle in view of preventing stinging stay onto the steel wire surface.

(Water Amount Controlling Step P3)

In the water amount controlling step P3, adjustment is made so as to maintain the water amount on the steel wire surface to be high after the descaling step P2 of the steel wire until introduction into the coating film treatment step P5 by the water retention step P31 and to decrease the water amount on the steel wire surface by the water reduction step P32.

Specifically, water given by the wet blasting remains on the steel wire after the descaling step P2. The water naturally falls off from the steel wire or is evaporated after the descaling step P2 and before the coating film treatment step P5, so that the water amount on the steel wire surface gradually decreases. Further, when the water amount on the surface of the steel wire goes down to be less than a prescribed amount, the surface of the steel wire is not covered with a water film and is exposed to the outside, whereby atmospheric corrosion is liable to occur on the steel wire surface. In order to prevent such atmospheric corrosion of the steel wire, the water retention step P31 of increasing the water amount on the surface of the steel wire is performed. Since the water film is formed on the surface of the steel wire by the water retention step P31, occurrence of atmospheric corrosion on the surface of the steel wire can be suppressed.

On the other hand, according as the water amount on the surface of the steel wire is increased, the water film is more liable to block the formation of the coating film in the coating film treatment step P5, thereby making it difficult to form a coating film on the surface of the steel wire. For this reason, the water reduction step P32 of decreasing the water amount on the surface of the steel wire is performed before carrying out the coating film treatment step P5 on the steel wire. By this water reduction step P32, the coating film can be efficiently formed on the surface of the steel wire in the subsequent coating film treatment step P5.

In the water amount controlling step P3, the water amount on the steel wire surface immediately before performing the coating film treatment step P5 is adjusted to be 5 g/m² or more and 80 g/m² or less. When the water amount is 5 g/m² or more, the water film formed over the whole surface of the steel wire suppresses diffusion of oxygen and makes the atmospheric corrosion on the surface of the steel wire less liable to proceed. When the water amount of the steel wire is small, the water film formed on the surface of the steel wire is too thin, so that oxygen is diffused in the water film, and rusts are liable to be generated. Moreover, part of the surface of the steel wire is exposed to atmospheric air to generate a local cell, so that the atmospheric corrosion of the steel is promoted. On the other hand, when the water amount on the surface of the steel wire is 80 g/m² or less, the water adhering onto the surface of the steel wire is less likely to block the formation or adhesion of the coating film. Preferably, the water amount on the surface of the steel wire is adjusted to be 8 g/m² or more and 60 g/m² or less.

(Water Retention Step P31)

The water retention step P31 is carried out to replenish water so that the water amount that is on the surface of the steel wire and that gradually decreases during the period of time from the descaling step P2 to the coating film treatment step P5, is kept within a prescribed numerical range. When the period of time or distance from the descaling step P2 to the coating film treatment step P5 is long, the water retention step P31 may be carried out for two or more times. Here, a mode of performing the water retention step P31 for two times will be described in Embodiment 4 mentioned later.

A specific method of performing the water retention step P31 is not particularly limited as long as the method can supply water to the steel wire, and a method such as showering of spraying water towards the steel wire or immersion of the steel wire into a water tank can be used. In any of the cases in which water is supplied by one of these methods, it is preferable that the supplied water has a temperature from ordinary temperature to about 40° C. at the highest in view of preventing atmospheric corrosion on the steel wire surface. Here, when water is introduced onto the steel wire surface by the aforementioned method, it is difficult to introduce a suitable amount of water onto the steel wire surface, so that the water amount on the steel wire surface is preferably decreased to 80 g/m² or less by performing the water reduction step P32 mentioned later immediately before the coating film treatment step P5.

(Water Reduction Step P32)

The water reduction step P32 is carried out to decrease the water amount when the water amount on the steel wire surface immediately before the coating film treatment step P5 is large. A specific method of performing the water reduction step P32 is not particularly limited as long as the method can supply water to the steel wire, so that wiping with air or a brush, or the like may be used. When wiping with air is performed, the air preferably has a temperature from ordinary temperature to about 40° C. at the highest in view of preventing atmospheric corrosion on the steel wire surface. The pressure of the air is appropriately changed also in accordance with the distance between a blowing outlet of air and the steel wire, or the like; however, the pressure of air is preferably set to be, for example, 0.1 MPa or more and 0.4 MPa or less. Adjustment of the pressure of air is preferably carried out by preparing a calibration curve showing a relationship between the water amount on the steel wire surface and the air pressure in advance and, while measuring the water amount on the steel wire surface with use of an aquameter, increasing or decreasing the pressure of air by feedback of the value of the measurement. Control of the pressure of air will be described later.

(Water Amount Measuring Step P4)

In the water amount measuring step P4, the water amount on the surface of the steel wire immediately before performing the coating film treatment step P5 is measured with use of an aquameter 6. Here, the “water amount on the surface of the steel wire immediately before performing the coating film treatment step” means a value obtained by measuring the water amount in the uppermost part of the surface of the steel wire in a strand state that flows through the line with use of an aquameter (an infrared non-contact type aquameter IRMA6194S manufactured by Chino Corporation) disposed on a 100 mm upstream side (the side of paying out the steel wire) of the point at which the coating film starts being formed in the coating film treatment step P5. Such disposal position of the aquameter 6 has been considered so that a coating liquid of the coating film treatment step P5 may not adhere to a sensor or the like of the aquameter 6. Measurement values obtained by the aquameter 6 do not differ greatly as long as the aquameter 6 is disposed within a range of 50 to 300 mm upstream side of the point at which the coating film starts being formed in the coating film treatment step P5. Within the above range, the disposal position of the aquameter 6 can be moved forward or backward in accordance with the circumstances.

(Coating Film Treatment Step P5)

In the coating film treatment step P5, a coating film having lubricity is formed on the steel wire whose water amount has been adjusted. By forming such a coating film, formability can be imparted to the steel wire when the steel wire is subjected to drawing. For the coating film treatment step P5, either one of the chemical reaction type coating film treatment and the physical adhesion type coating film treatment may be used.

The chemical reaction type coating film treatment is carried out by the following procedure. First, the steel wire is subjected to immersion or spraying of a phosphate containing solution, so as to form a base layer (phosphate coating film). Subsequently, a lubricant such as lime soap or sodium stearate is applied onto the surface of the base layer. The physical adhesion type coating film treatment is carried out by applying a lubricant such as lime soap onto the steel wire by immersion or spraying.

(Drying Step P6)

When a lubricant used in the coating film treatment step P5 is a liquid, the surface treatment line preferably includes a drying step P6 for drying the lubricant. The drying in the drying step P6 may be carried out by blowing hot air with use of a drying device 16 such as a drier or the like method. The drying temperature is preferably set to be 60° C. or higher and 250° C. or lower, and the drying time is preferably set to be 1 second or more and 60 seconds or less.

(Coiling Step P7)

In the coiling step P7, the steel wire on which the above coating film has been formed is coiled with use of a coiling machine 17. A coiling method can be used without any particular limitation.

<Surface Treatment Line>

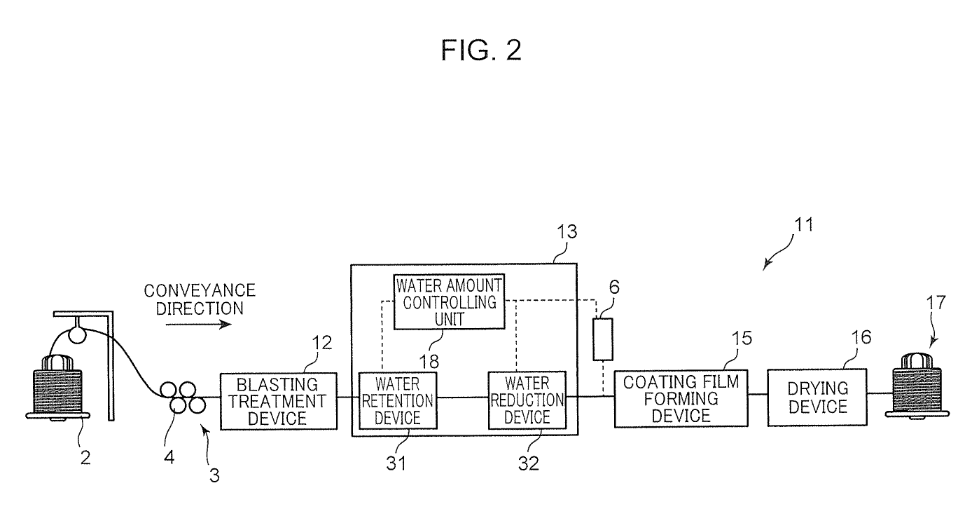

Referring to FIG. 2, a surface treatment line 11 used in the steel wire surface treatment method of Embodiment 1 includes a blasting treatment device 12 for performing a wet blasting treatment on the surface of the steel wire, a coating film forming device 15 for forming a coating film on the steel wire after wet blasting, and a water amount controlling device 13 for adjusting a water amount on the steel wire surface immediately before introducing the steel wire into the coating film forming device 15, to be 5 g/m² or more and 80 g/m² or less.

The blasting treatment device 12 is a device for performing wet blasting on the steel wire. Specifically, on the surface of the steel wire, a slurry obtained by mixing water with hard particles is sprayed towards an object with use of high-pressure air from a plurality of nozzles. This can cut out the oxide scale adhering onto the steel wire surface and can roughen the surface.

For the coating film forming device 15, either one of a chemical reaction type device and a physical adhesion type device may be used. The chemical reaction type device may be, for example, a device in which an immersion tank for immersing the steel wire into a phosphate containing solution and an immersion tank for immersing the steel wire into a lubricating solution containing lime soap, sodium stearate, or the like are disposed in this order. The physical adhesion type device may be, for example, a device of spraying a lubricant such as lime soap onto the steel wire.

The water amount controlling device 13 includes a water retention device 31 for increasing the water amount on the surface of the steel wire, a water reduction device 32 for decreasing the water amount on the surface of the steel wire, and a water amount controlling unit 18 for controlling adjustment of the water amount on the steel wire surface by changing the conditions of the water retention device 31 and the water reduction device 32. The water retention device 31 may be, for example, a showering device for spraying water towards the steel wire, a water tank for immersion of the steel wire, or the like. The water reduction device 32 may be, for example, a wiping device using air or a brush, or the like. The water amount controlling unit 18 controls driving or stopping of the water retention device 31, or conditions such as air pressure of the water reduction device 32.

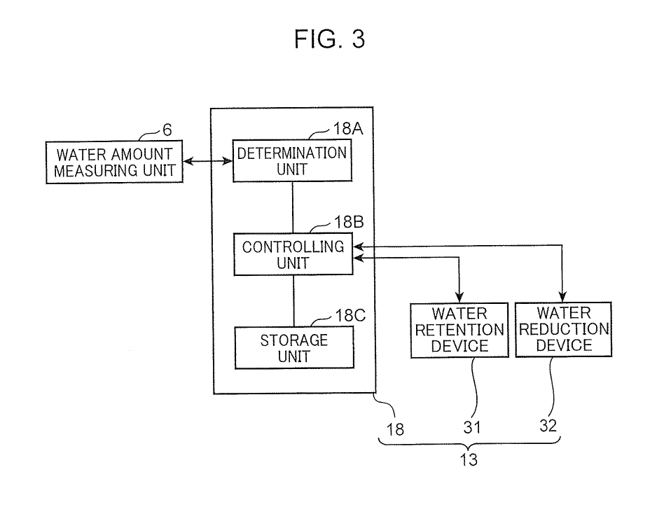

With reference to FIG. 3, a method of controlling the water amount on the steel wire surface by the water amount controlling unit 18 will be described. The water amount controlling unit 18 is mainly made of a determination unit 18A, a controlling unit 18B, and a storage unit 18C. Results of measurement of the water amount on the steel wire surface by a water amount measuring unit (aquameter 6) are input into the determination unit 18A. Further, the storage unit 18C stores data of a prescribed numerical range of the water amount on the steel wire surface. The determination unit 18A makes a comparison between the results of measurement that are input from the aquameter 6 and the prescribed numerical range (for example, 5 g/m² or more and 80 g/m² or less) that is stored in the storage unit 18C, so as to determine whether or not there is a need to change the water amount on the steel wire surface on the basis of the results of comparison. More specifically, the determination unit 18A determines that there is a need to increase the water amount of the steel wire by the water retention device 31 when the measurement value of the water amount is below a lower limit of the prescribed numerical range. On the other hand, the determination unit 18A determines that there is a need to decrease the water amount of the steel wire by the water reduction device 32 when the measurement value is above an upper limit of the prescribed numerical range. Further, the determination unit 18A determines that there is no need to change the water amount on the steel wire surface when the measurement value of the water amount by the aquameter 6 is within the prescribed numerical range.

The above determination results given by the determination unit 18A are input into the controlling unit 18B and, on the basis of this, the controlling unit 18B controls operations of the water retention device 31 and the water reduction device 32. More specifically, when the determination unit 18A determines that there is a need to increase the water amount on the steel wire surface, the controlling unit 18B starts up the water retention device 31 or lowers the air pressure of the water reduction device 32 so as to increase the water amount on the steel wire surface. On the other hand, when the determination unit 18A determines that there is a need to decrease the water amount on the steel wire surface, the controlling unit 18B stops the starting up of the water retention device 31 or raises the air pressure of the water reduction device 32 so as to decrease the water amount of the steel wire. In this manner, the water amount controlling unit 18 can adjust the water amount on the steel wire surface to be within the prescribed numerical range by adjusting the water amount on the steel wire surface while feeding the results of measurement of the water amount on the steel wire surface back to the controlling unit 18B.

Here, the present invention is not limited to the case of automatic adjustment of the water amount on the steel wire surface by using the water retention device 31 and the water reduction device 32 as in the present embodiment, so that the construction of the water amount controlling unit 18 may be omitted, and manual operation by a user may drive or stop the water retention device 31 and the water reduction device 32, or may adjust the air pressure or the like of the water reduction device 32 on the basis of the results of measurement given by the aquameter 6.

<Adjustment of Water Amount on Steel Wire Surface by Water Amount Controlling Device>

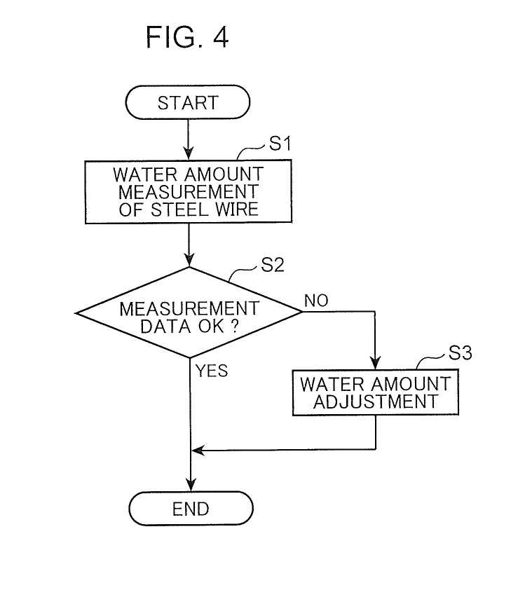

Next, a method of adjusting the water amount on the steel wire surface in the above surface treatment line 1 will be described with reference to the flowchart shown in FIG. 4.

First, the controlling unit 18B makes the aquameter 6 measure the water amount on the steel wire surface immediately before the coating film treatment step P5 for a predetermined period (for example, every 10 minutes) (S1). Here, the obtained measurement data are input into the determination unit 18A.

Next, the determination unit 18A makes a comparison between the measurement data that are input and the prescribed numerical range data that are stored in the storage unit 18C. Then, the determination unit 18A determines whether or not the measurement data are within the prescribed numerical range (for example, whether or not the measurement data are within a range of 5 g/m² or more and 80 g/m² or less) (S2). Further, when the determination unit 18A determines that the measurement data are out of the prescribed numerical range (S2: NO), the determination results are input into the controlling unit 18B. Then, the controlling unit 18B drives or stops the water retention device 31 or the water reduction device 32 so that the water amount comes within the prescribed numerical range (S3).

More specifically, when the measurement data are below the lower limit of the prescribed numerical range and there is a need to increase the water amount, the controlling unit 18B drives the water retention device 31 or stops the water reduction device 32, or lowers the air pressure of the water reduction device 32. On the other hand, when the measurement data are above the upper limit of the prescribed numerical range and there is a need to decrease the water amount, the controlling unit 18B stops the water retention device 31 or drives the water reduction device 32, or raises the air pressure of the water reduction device 32. In this manner, the controlling unit 18B drives or stops the water retention device 31 or the water reduction device 32, or adjusts the air pressure of the water reduction device 32 so that the water amount on the steel wire surface comes within the prescribed numerical range. Further, when the determination unit 18A determines that the measurement data of the water amount are within the prescribed numerical range (S2: YES), the conditions of the water retention device 31 and the water reduction device 32 such as described above are maintained as they are without being changed.

### Embodiment 2

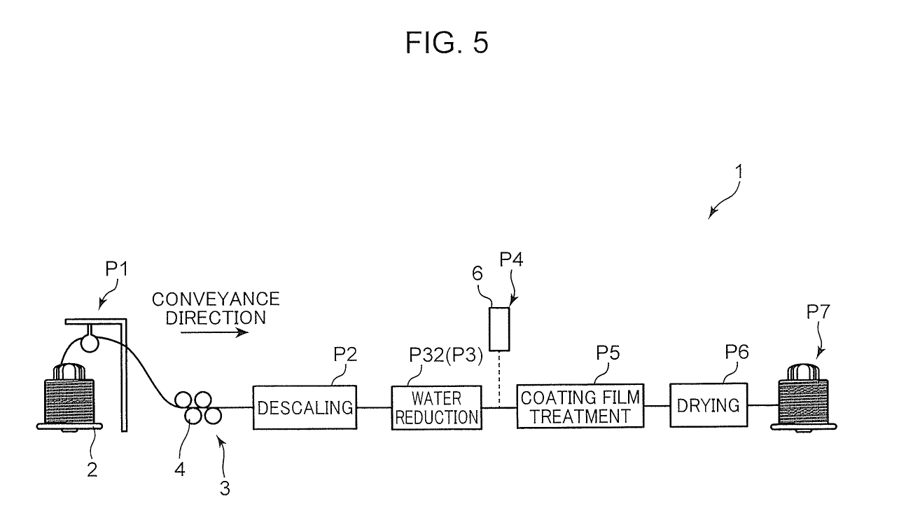

The steel wire surface treatment method of Embodiment 2 is the same as that of Embodiment 1 except that the water retention step P31 is not carried out, as shown in FIG. 5, as compared with that of Embodiment 1. In other words, in Embodiment 2, only the water reduction step P32 is carried out in the water amount controlling step P3, and the water retention step P31 is not carried out. Embodiment 2 is effective, for example, when the period of time (distance) from the descaling step P2 to the coating film treatment step P5 is short. When this period of time (distance) is short, the steel wire is introduced into the coating film treatment step P5 in a state in which the water given by the wet blasting in the descaling step P2 still remains on the surface of the steel wire. For this reason, there is no need to replenish water separately by the water retention step P31, and it is sufficient that the water amount on the steel wire surface is decreased by the water reduction step P32 immediately before the steel wire is introduced into the coating film treatment step P5.

### Embodiment 3

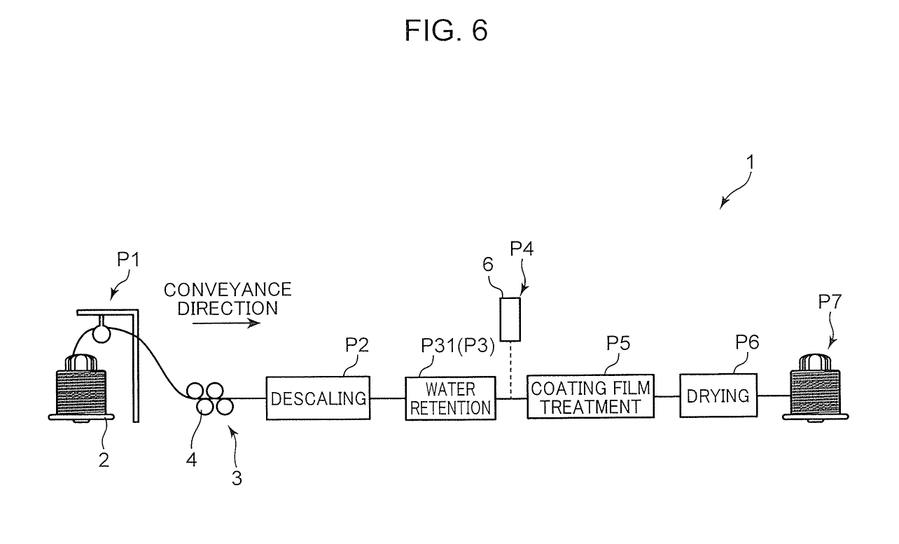

The steel wire surface treatment method of Embodiment 3 is the same as that of Embodiment 1 except that the water reduction step P32 is not carried out, as shown in FIG. 6, as compared with that of Embodiment 1. In other words, in Embodiment 3, only the water retention step P31 is carried out in the water amount controlling step P3, and the water reduction step P32 is not carried out. Embodiment 3 is effective, for example, when the period of time (distance) from the descaling step P2 to the coating film treatment step P5 is long. When this period of time (distance) is long, the water given by the wet blasting in the descaling step P2 naturally falls off from the steel wire or is evaporated, and the water amount on the surface of the steel wire tends to be insufficient. For this reason, water is replenished separately by the water retention step P31. The water retention step P31 is preferably carried out at a timing at which the water amount on the surface of the steel wire becomes insufficient (for example, at a timing at which the water amount becomes 5 g/m² or less). The water retention step P31 is carried out so that the water amount on the steel wire surface immediately before the steel wire is introduced into the coating film treatment step P5 is 80 g/m² or less.

### Embodiment 4

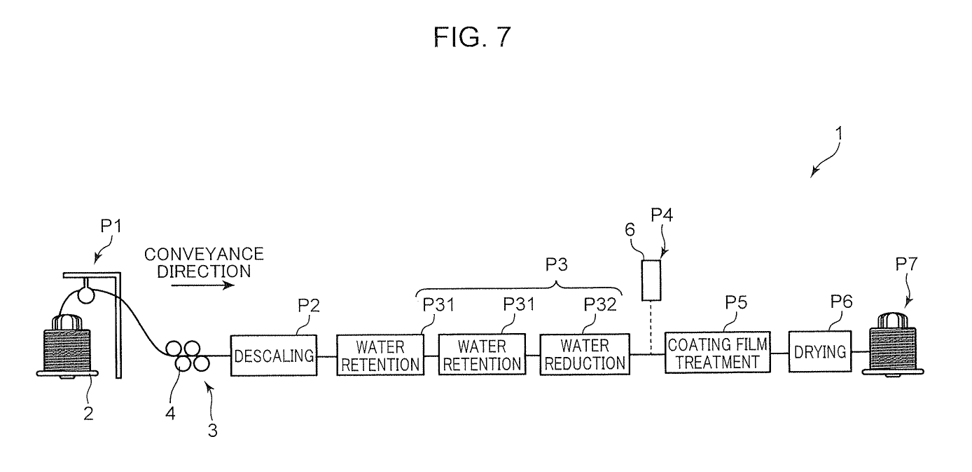

The steel wire surface treatment method of Embodiment 4 is the same as that of Embodiment 1 except that the water retention step P31 is further carried out, as shown in FIG. 7, as compared with that of Embodiment 1. In other words, in Embodiment 4, the water reduction step P32 is carried out after the water retention step P31 is carried out for two times in the water amount controlling step P3. Embodiment 4 is effective, for example, when the period of time (distance) from the descaling step P2 to the coating film treatment step P5 is further longer than that of Embodiment 3. When this period of time (distance) is long, the water naturally falls off or is evaporated again from the steel wire even after the water amount is once increased in the water retention step P31, so that the water amount on the surface of the steel wire becomes insufficient. Water is replenished again by the water retention step P31 of the second time before the water amount becomes insufficient. A preferable timing for carrying out the water retention step P31 is the same as the timing described in Embodiment 3 mentioned above.

Here, in Embodiment 4, a case of performing the water retention step P31 for two times has been described; however, the water retention step P31 may be carried out for three or more times when the period of time (distance) from the descaling step P2 to the coating film treatment step P5 is further longer.

As described above, according the aforementioned embodiments, there are provided a steel wire surface treatment method and a steel wire surface treatment line that form a coating film having a good quality on the steel wire by suppressing the atmospheric corrosion that is liable to occur during the surface treatment processes of the steel wire.

The steel wire surface treatment method according the above embodiments is characterized by including a descaling step of removing scale adhering to the surface of the steel wire by subjecting the surface of the steel wire to wet blasting; a coating film treatment step of forming a coating film on the surface of the steel wire after the descaling step; and a water amount controlling step of adjusting a water amount on the surface of the steel wire immediately before performing the coating film treatment step, to be within a prescribed water amount range.

According to the above embodiments, the water film formed over the whole surface of the steel wire suppresses diffusion of oxygen by adjustment of the water amount on the surface of the steel wire after the water amount controlling step and immediately before performing the coating film treatment step to be within a prescribed water amount range. This suppresses the atmospheric corrosion of the steel wire, and the coating film can be formed efficiently in the coating film treatment step. Further, by covering the surface of the steel wire with the water film, atmospheric corrosion of the steel wire caused by exposure of a part of the steel wire to atmospheric air can be prevented.

In the aforementioned embodiments, the steel wire surface treatment method further includes a water amount measuring step of measuring the water amount on the surface of the steel wire after the water amount controlling step and immediately before performing the coating film treatment step.

According to the above embodiments, the water amount on the surface of the steel wire immediately before performing the coating film treatment step can be controlled by measurement of the water amount on the surface of the steel wire immediately before performing the coating film treatment step, and therefore, the water amount can be adjusted so that the coating film can be formed efficiently on the surface of the steel wire.

In the above embodiments, the water amount controlling step adjusts the water amount on the surface of the steel wire immediately before performing the coating film treatment step, to be 5 g/m² or more and 80 g/m² or less.

According to the above embodiments, since the water amount on the steel wire surface is 5 g/m² or more, the water film formed over the whole surface of the steel wire suppresses diffusion of oxygen, and development of the atmospheric corrosion can be suppressed.

Moreover, since the surface of the steel wire can be covered with the water film, atmospheric corrosion of the steel wire caused by exposure of a part of the steel wire to atmospheric air can be prevented. On the other hand, since the water amount on the surface of the steel wire is 80 g/m² or less, the coating film can be formed efficiently in the coating film treatment step.

In the above embodiments, the water amount controlling step includes a water retention step of increasing the water amount on the surface of the steel wire after the descaling step P2.

According to the above embodiments, the water retention step can replenish the water amount that is on the steel wire surface and that gradually decreases during the period of time from the descaling step to the coating film treatment step P5, thereby eliminating insufficiency of the water amount on the steel wire surface and suppressing the occurrence of atmospheric corrosion on the steel wire surface.

In the above embodiments, the water amount controlling step includes a water reduction step of decreasing the water amount on the surface of the steel wire after the descaling step.

According to the above embodiments, the water reduction step can decrease the water amount on the steel wire immediately before the steel wire is introduced into the coating film treatment step, whereby the coating film can be formed efficiently on the steel wire surface.

The above embodiments also disclose a steel wire surface treatment line for continuously treating a surface of a steel wire, including: a blasting treatment device for performing wet blasting on the surface of the steel wire; a coating film forming device for forming a coating film on the steel wire after the wet blasting treatment; and a water amount controlling device for adjusting a water amount on the surface of the steel wire immediately before introducing the steel wire into the coating film forming device, to be within a prescribed water amount range.

According to the above embodiments, the water amount controlling device can adjust the water amount on the surface of the steel wire immediately before introducing the steel wire into the coating film forming device, so that the atmospheric corrosion caused by insufficiency of the water amount on the steel wire surface can be suppressed, and a situation in which the water amount becomes excessive can be suppressed, whereby the coating film can be formed efficiently on the steel wire surface.

In the aforementioned embodiments, the steel wire surface treatment line further includes an aquameter for measuring the water amount on the surface of the steel wire immediately before performing the coating film treatment step.

According to the above embodiments, the aquameter can control the water amount on the surface of the steel wire immediately before performing the coating film treatment step, and therefore, the water amount can be adjusted so that the coating film can be formed efficiently on the surface of the steel wire.

In the aforementioned embodiments, the water amount controlling device adjusts the water amount on the surface of the steel wire immediately before introducing the steel wire, to be 5 g/m² or more and 80 g/m² or less.

According to the above embodiments, since the water amount on the steel wire surface is 5 g/m² or more, the water film formed over the whole surface of the steel wire suppresses diffusion of oxygen, and development of the atmospheric corrosion can be suppressed. Moreover, since the surface of the steel wire can be covered with the water film, atmospheric corrosion of the steel wire caused by exposure of a part of the steel wire to atmospheric air can be prevented. On the other hand, since the water amount on the surface of the steel wire is 80 g/m² or less, the coating film can be formed efficiently in the coating film treatment step.

In the above embodiments, the water amount controlling device includes a water retention device 31 for increasing the water amount on the surface of the steel wire.

According to this construction, the water retention device can replenish the water that is on the steel wire surface and that gradually decreases during the period of time from the descaling step to the coating film treatment step, thereby suppressing the atmospheric corrosion of the steel wire caused by insufficiency of the water amount on the steel wire surface.

In the above embodiments, the water amount controlling device includes a water reduction device for decreasing the water amount on the surface of the steel wire.

According to the above embodiments, the water reduction device can decrease the water amount on the steel wire immediately before the steel wire is introduced into the coating film treatment step P5, whereby the coating film can be formed efficiently on the surface of the steel wire.

### EXAMPLES

Next, functions and effects of the surface treatment method of the present invention will be described in detail by making reference to Examples.

### Example 1

In the present Example, a hot-rolled wire having a diameter of 12.5 mm (alloy steel material SCM435 for mechanical structures: JIS G4053:2008) was paid out at a conveyance speed of 10 m/min from a coil fixed to the supply stand 2 and subjected to the descaling step P2, water amount controlling step P3 (water retention step P31 and water reduction step P32), coating film treatment step P5, drying step P6, and coiling step P7 in this order. Details of the experiment conditions are as follows. Here, the distance after finishing the wet blasting in the descaling step P2 until starting the coating film formation in the coating film treatment step P5 was 5 m. For this reason, the period of time from the finishing of the wet blasting to the coating film formation was 30 seconds.

(Descaling Step P2)

Device for use: general-purpose wet blasting device manufactured by Macoho Co., Ltd.

Air pressure: 0.4 to 0.6 MPa

Distance between the steel wire and the nozzle: 100 to 150 mm

Abrasive grains: GRITTAL GH10 manufactured by VULKAN INOX GmbH.

Abrasive grain concentration in the slurry: 15% to 25%

Solvent used in the slurry: industrial water

(Water Amount Controlling Step P3)

(Water Reduction Step P32)

The water amount on the steel wire was decreased by performing air wiping on the steel wire of each Example under the following conditions.

Air wiping (air wiper WK-25 manufactured by BLS Co., Ltd.)

Air pressure: 0.05 MPa to 0.45 MPa (air wiping was carried out with an air pressure shown in the section of “Wiping air pressure” in Table 1 of each Example)

Air temperature: ordinary temperature (about 20° C.)

Position of air wiping: position of 250 mm from the end point of the wet blasting device (Coating film treatment step P5)

Lubricant for use: lime soap adjusted to have a solid component concentration of 20±1 wt % (MAC-A20 manufactured by Inoue Calcium Corporation)

Coating film treatment device (Borax Application Device B-KM manufactured by Miyazaki Machinery Systems Co., Ltd.)

(Drying Step P6)

Drying temperature: 150 seconds

Drying time; 10 seconds

TABLE 1

| | | | Coating film | | |
|---|---|---|---|---|---|
| | Wiping air | Water | adhesion | | |
| | pressure | amount | amount | Rusting time | |
| | (MPa) | (g/m²) | (g/m²) | Hours | Evaluation |
| Example 1 | 0.40 | 6.2 | 7.7 | 30 | ◯ |
| Example 2 | 0.35 | 9.8 | 7.4 | 58 | ⊙ |
| Example 3 | 0.15 | 46.7 | 6.3 | 73 | ⊙ |
| Example 4 | 0.10 | 73.6 | 5.1 | 42 | ◯ |
| Example 5 | 0.45 | 4.1 | 8.0 | 19 | Δ |
| Example 6 | 0.05 | 91.5 | 3.8 | 17 | Δ |

The “Water amount” in Table 1 is a measurement value of the water amount at the uppermost part of the steel wire surface obtained by an aquameter disposed at a position immediately before the steel wire is brought into liquid contact with a coating film solution (the position that is 100 mm back towards the prior side of the paying-out direction from the liquid contact). The measurement value of the water amount was calculated by the following procedure. First, infrared absorbance was measured at a measurement sampling rate of 1 Hz over the whole length of the steel wire by irradiating the uppermost part of the steel wire with an infrared ray of a fiber sensor of an aquameter (an infrared non-contact type aquameter IRMA6194S manufactured by Chino Corporation). Also, a calibration curve showing the relationship between the infrared absorbance and the water amount was prepared in accordance with JIS Z8461. The value of the infrared absorbance measured in the above was applied to the above calibration curve to convert the value into the water amount wt.

The “Coating film adhesion amount” in Table 1 is a value calculated in the following manner. First, three test pieces, each having a length of 100 mm, are cut out at random from each of the steel wires fabricated in the Examples. Next, each test piece is immersed into a 5 wt % aqueous solution of chromic acid at 100° C. for 20 minutes to dissolve or peel off the coating film of the steel wire. Then, an average of three times of the values, each obtained by dividing the change in weight of the test piece by the surface area of the test piece, is calculated to obtain the coating film adhesion amount.

The “Rusting time” in Table 1 was calculated by the following procedure. First, three test pieces, each having a length of 100 mm, were cut out at random from the steel wire fabricated in each Example. Next, each test piece was set in a constant-temperature and constant-humidity environment (temperature of 30° C., humidity of 70%, Combined Cyclic Corrosion Test Instrument CYP-90A manufactured by Suga Test Instruments Co., Ltd.) and thereafter, presence or absence of generation of spot rusts was confirmed by eye inspection for every one hour. Further, an average of three times of the periods of time, each until the generation of spot rusts, was calculated to obtain the rusting time. The rusting time was evaluated according to the following standard and listed in the section of “Evaluation” in Table 1.

<Evaluation Standard of Rusting Time>

⊙: 48 hours (two days) or more

◯: 24 hours or more and less than 48 hours

Δ: rusting time is less than 24 hours (1 day)

<Effects>

From the evaluation results of the rusting time in each of the Examples given above, it has been made clear that a coating film having a sufficient weight can be formed on the surface of the steel wire and that the rusting time of the coating film can be ensured to be long when the water amount on the surface of the steel wire immediately before performing the coating film treatment step is adjusted to be 5 g/m² or more and 80 g/m² or less.

By comparison of the data of “water amount” and “coating film adhesion amount” in Examples 1 to 4, it has been made clear that, according as the water amount on the surface of the steel wire increases, the coating film is less likely to be formed. This suggests that the water on the surface of the steel wire blocks the coating film formation.

By comparison of the data of “water amount” and “rusting time” in Examples 1 to 4, a tendency is noted such that the rusting time is shorter when the water amount on the surface of the steel wire is either larger or smaller. When the water amount on the steel wire surface is smaller, it seems that a part of the steel wire is exposed, and atmospheric corrosion proceeds at that part. Conversely, when the water amount on the steel wire surface is larger, it seems that the rusting time is shorter because the coating film is less likely to be formed on the steel wire surface. From these results, it has been made clear that the water amount on the steel wire surface immediately before the coating film treatment step P5 is preferably 8 g/m² or more and 60 g/m² or less.

In Example 5, the water amount on the steel wire surface was less than 5 g/m² (water amount was 4.1 g/m²), and accordingly, the rusting time was shorter despite the fact that a sufficient amount of the coating film was formed on the steel wire surface. This seems to be due to the fact that, because the water amount on the steel wire surface from the descaling step P2 till the coating film treatment step P5 was small, a part of the steel wire was exposed, and atmospheric corrosion proceeded at that part.

In Example 6, the water amount on the steel wire surface exceeded 80 g/m² (water amount was 91.5 g/m²), and accordingly, it seems that the water blocked the coating film formation in the subsequent coating film treatment step P5, and the rusting time was shorter because a sufficient amount of the coating film was not formed.

Here, it is to be understood that the embodiments herein disclosed are illustrative in all respects and are not limitative. In particular, the matters that are not explicitly disclosed in the embodiments herein disclosed, for example, operation conditions and various parameters as well as dimension, weight, volume, and the like of the constituent elements, do not depart from the range in which those skilled in the art generally put into practice, and values that are readily conceivable by those generally skilled in the art are adopted.

1. A steel wire surface treatment method for continuously treating a surface of a steel wire, the method comprising:
removing scale adhering to the surface of the steel wire by subjecting the surface of the steel wire to wet blasting;
forming a coating film on the surface of the steel wire after the removing; and
controlling a water amount by adjusting a water amount on the surface of the steel wire immediately before the forming, to be within a prescribed water amount range.

2. The steel wire surface treatment method according to claim 1, further comprising: measuring the water amount on the surface of the steel wire after the controlling and immediately before the forming.

3. The steel wire surface treatment method according to claim 1, wherein the controlling comprises adjusting the water amount on the surface of the steel wire immediately before the forming, to be 5 g/m² or more and 80 g/m² or less.

4. The steel wire surface treatment method according to claim 1, wherein the controlling comprises increasing the water amount on the surface of the steel wire after the removing.

5. The steel wire surface treatment method according to claim 1, wherein the controlling comprises decreasing the water amount on the surface of the steel wire after the removing.

6. A steel wire surface treatment line, comprising:
a blasting treatment device for performing wet blasting on a surface of a steel wire;
a coating film forming device for forming a coating film on the steel wire after wet blasting treatment; and
a water amount controlling device for adjusting a water amount on the surface of the steel wire immediately before introducing the steel wire into the coating film forming device, to be within a prescribed water amount range.

7. The steel wire surface treatment line according to claim 6, further comprising:
an aquameter for measuring the water amount on the surface of the steel wire immediately before forming the coating film.

8. The steel wire surface treatment line according to claim 6, wherein the water amount controlling device adjusts the water amount on the surface of the steel wire immediately before introducing the steel wire, to be 5 g/m² or more and 80 g/m² or less.

9. The steel wire surface treatment line according to claim 6, wherein the water amount controlling device comprises a water retention device for increasing the water amount on the surface of the steel wire.

10. The steel wire surface treatment line according to claim 6, wherein the water amount controlling device comprises a water reduction device for decreasing the water amount on the surface of the steel wire.
